(19) United States
(12) Patent Application Publication
(10) Pub. No.: US 2005/0144226 A1
(43) Pub. Date: Jun. 30, 2005

(54) Systems and methods for modeling and generating reusable application component frameworks, and automated assembly of service-oriented applications from existing applications

(75) Inventor: Steven Purewal, Frazer Town Bangalore (IN)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Churchill Software Services, Bangalore (IN)

(21) Appl. No.: 10/985,845

(22) Filed: Nov. 9, 2004

Related U.S. Application Data
(60) Provisional application No. 60/519,168, filed on Nov. 10, 2003.

(51) Int. Cl. G06F 15/16

(52) U.S. Cl. 709/203

(57) ABSTRACT

Embodiments of systems and methods model and generate open reusable, business components for Service Oriented Architectures (SOAs) from existing client/server applications. Applications are decomposed into business component frameworks with separate user interface, business logic, and event management layers to enable service-oriented development of new enterprise applications. Such layers are re-assembled through an open standards-based, Native Application Services (NAS) to render similar or near identical transactional functionality within a new application on an open platform, without breaking former production code, and without requiring a change in an end-user's business processes and/or user experience. In addition, the same separated layers may form re-usable business components at any desired level of granularity for re-use in external composite applications through industry-standard interfaces, regardless of usage, context, or complexity in the former Client/Server application.

### CROSS-REFERENCE TO RELATED APPLICATION

This application claims priority to Provisional Application Ser. No. 60/519,168 entitled “ENTERPRISE SOFTWARE PLATFORM FOR AUTOMATING GENERATION OF CLIENT-SERVER APPLICATIONS TO OPEN APPLICATIONS”, the disclosure of which is hereby incorporated herein by reference.

### TECHNICAL FIELD

The present invention is broadly related to enterprise software, and systems implementing same. The present invention is more specifically related to systems and methods for modeling existing applications and generating open, reusable, business service and system service component frameworks, and/or the framework-based assembly of service-oriented applications from existing applications, such as Graphical User Interface (GUI)-implemented client/server applications.

### BACKGROUND OF THE INVENTION

In over two decades of computing, from 1980 to 2000, the absence of computing standards has seen billions of dollars of Information Technology (IT) investment expended on client/server database applications in vendor-proprietary technologies. Industry-defining standards, such as Java 2 Enterprise Edition (J2EE) and distributed service-oriented architectures, providing vastly simplified application interoperability, such as through XML-based Web Services, have arisen. However, no automated software solution exists to bridge legacy client/server application technology with the new-generation, open standards-based platforms, such as J2EE platforms, or the like. Specifically, there exists no software solution to completely migrate legacy client/server applications in a given technology base to J2EE, that looks and behaves similar to proprietary version, with little manual effort post-migration in order to render the migrated J2EE-equivalent operational as before in client/server, but now consistent with new business objectives for non-proprietary and open standards-based architecture.

In the decade of the 1990s, custom client/server database application development was characterized by the absence of standards, which led to the emergence of vendor-proprietary approaches to offering client/server database application development tools. End customers were forced to choose among popular development tools such as Microsoft Visual Basic™, Oracle™ Forms, Powersoft Powerbuilder™, SAP ABAP™, and others, and the evolution of these offerings to their current naming and packaging today. In the decade of 2000, powerful new standards, which started as early laboratory technology in the late 1990s, have matured to provide a proven technology basis for new generation, non-proprietary, interoperable, enterprise-grade mission-critical computing. One such powerful and market-leading standard is J2EE.

However, while J2EE defines standards for building new applications through provision of a set of open Application Programming Interfaces (APIs), there has not existed a fully automated software-based solution to migrate already-built “legacy” custom applications to the new J2EE environment. Since enormous investments have already been made over several years of refining custom client/server applications, in software, consulting, training, and support, customers have been reluctant to blindly re-engineer their enterprise applications to the J2EE computing platform. Likewise, customers have been reluctant to abandon their enterprise applications for alternative J2EE-based applications if such applications exist, or to rebuild enterprise applications from scratch. The cost of re-engineering has implied a manual, consultant-driven services approach to grapple, dissect, and fully comprehend the anatomy, function, technology, and usage of a highly-complex application that has evolved over several years.

Additionally, the new standards, such as defined by J2EE, offer a plethora of technology, implementation, and best-practice choices that make the job of manually selecting the best approach for a particular aspect of a given application developed in a now-legacy client/server technology an incredibly challenging one. Identification of requisite technology skills that can span well across both client/server and J2EE environments, with a proven approach to providing the step-by-step fidelity of the original application's appearance and behavior, as typically demanded by application end-users, in all respects, is a highly costly proposition when viewed from a labor-intensive manual approach. Further, when considered with the need to make any manually migrated application readily maintainable and extensible to meet new business needs, the choice of a scalable design-time and run-time architecture becomes even more critical. Combined, these factors make the cost of manual-migration of enterprise-grade mission-critical applications simply too high and risk-laden, and impractical for most organizations to execute, even if the effort delivers the expected results. The alternative of applying a hybrid approach through adoption of partial-generation “migration wizards” is highly risk-laden, as inconsistencies between the tool-generated application software and that delivered manually, stemming from the inherent trade-off in electing to work within the constraints of the tool or to supplement and compensate with broader functionality manually, may give rise to programming practices incongruent with best-practices design patterns and software architectures precluding the delivered application from exploiting the full benefits of open application server software. Therefore, in order to realize the highly desirable attributes of sound and scalable architecture, high-performance, and a maintainable J2EE code in standard Java IDEs, enterprise-grade mission-critical client/server applications need to be constructed.

Further, migration to an open standards based application often involves retraining of personnel or employment of new and/or additional personnel to provide developer and/or user skills necessary to fully implement the new open standards-based application(s). For such staff, and in particular application developers, the use of new development tools associated with the new technology platform will incur steep and extensive learning curves to gain skills to productively employ such tools to address the complexity of the new technology platform.

Further, a migration to an open standards-based application may require the integration and incorporation of new business processes or procedures. Additionally, such a migration may require a “switch-over” from a legacy application to the new open standards-based application, not allowing for a gradual transition.

A Service Oriented Architecture (SOA) defines how two computing entities interact in such a way as to enable one entity to perform a unit of work on behalf of or in place of another entity. The unit of work is referred to as a service, and the service interactions are defined using a description language. Each interaction is self-contained and loosely coupled, so that each interaction is independent of any other interaction. The protocol independence of SOA means that different consumers can use services by communicating with the service in different ways. Typically a management layer is implemented between the providers and consumers to ensure complete flexibility regarding implementation protocols. A set of standards underpinning SOAs and implementing their characteristics in a platform-neutral way is rapidly emerging and is being implemented by many enterprise software vendors to describe services and define interactions using platform-independent standards (XML). These developments are shifting the focus of contemporary business applications development from technology-oriented perspectives to business services. An SOA promotes re-use of software assets across existing, new and heterogeneous applications when these software programs are implemented as loosely coupled services. A single application most often will not meet all the needs of an enterprise. Thus, business processes within an enterprise are typically implemented by multiple applications. SOA and service-oriented application development promote new composite process-based applications by enabling presentation, aggregation, and integration of functionality for more effective and meaningful support of an organization's business processes.

### SUMMARY

Embodiments of the present systems and methods model, generate, and manage open, reusable, business components for SOAs from existing source applications, such as GUI client/server applications. For example, embodiments of the present systems and methods decompose monolithic existing applications into open standards-based, re-usable business components with separate user interface, business logic, and event management layers. Such layers may be linked at run-time through an open standards-based, Native Application Services (NAS) that renders a similar or near-identical appearance, a similar or near-identical behavior application, without breaking production code of the existing application, and without requiring a change in an end-user's business processes and/or user experience. In addition, the same separated layers may form re-usable business components at desired levels of granularity (partitioning and representation) for re-use in external applications through industry-standard interfaces, regardless of usage, context, or complexity in the former proprietary GUI client/server application.

In order to realize the highly desirable attributes of sound and scalable architecture, high-performance, and a maintainable J2EE code in standard Java IDEs, enterprise-grade mission-critical client/server applications, embodiments of the present systems and methods consistently employ proven and comprehensive J2EE business components that cleanly partition application code, using best-practice design patterns such as Model View Controller (MVC) architectures. The present systems and methods also preferably utilize the underlying platform API's optimized application server vendor frameworks at run time or, at design time expose their programming constructs to third-party development frameworks and modern Integrated Development Environments (IDEs) for ongoing declarative-based development. Embodiments of the present invention employ SOA and service-oriented application development to develop new composite process-based applications, enabling presentation, aggregation, and integration of functionality that has previously been locked away in vendors' proprietary application technologies. Advantageously, this provides for more effective and meaningful support of an organization's business processes.

Embodiments of the present systems and methods may migrate core business assets, presently locked-up in proprietary client/server applications and preferably preserve and fully leverage these assets using an open standard, such as J2EE, without loss of appearance and function of the original client/server application. For example, in accordance with embodiments of the present invention, a legacy application's GUI elements, User Interface(UI)-bound business logic, behavior, navigation, business logic, event management (hierarchy and flow), transaction semantics and management, concurrency control, and exception management operate in a fashion similar to or nearly identical to the legacy application in its J2EE-equivalent representation. By providing a true and faithful replica of these attributes that characterize the original client-sever application, a J2EE-migrated application preferably meets end-user, IT department, and business criteria to significantly lower migration risk. Also, solutions provided by embodiments of the present systems and methods preferably overcome resistance to change to new technologies among IT mangers and staff by providing tools that lower barriers to the conversion to the solution.

An embodiment of a method for generating and managing open, reusable, business components for SOAs from existing applications includes decomposing an existing application into one or more open standards-based business components in at least one framework and reassembling the layers into an open standards-based application for SOAs utilizing the framework(s). Another embodiment of a method for generating and managing open, reusable, business components for SOAs from existing applications includes decomposing an existing application into one or more open standards-based business components in one or frameworks and using the business components in an external SOA application according to the framework(s). In either of these, and other embodiments, the frameworks may include at least a business service component framework and a system services component framework.

Embodiments of the present systems and methods for modeling, generating, and managing open, reusable, business components for SOAs from existing applications might include parsing an existing application and deriving a platform-independent logical model to describe the application's business domain, functionality characteristics, and the requisite platform services for its implementation as the basis for generating one or more platform-specific application frameworks to be assembled into an equivalent open-standards application. The derived model may be reusable.

An embodiment of a system for modeling and generating reusable application component frameworks, and automated assembly of service-oriented applications from existing applications includes an application parser for decomposing an existing application into a logical source application model and producing application system model artifacts. A framework generator uses the logical source application model to generate open, reusable business service component and system service component frameworks. The frameworks may provide context-based and non-context-based business service components. An application builder generates services-oriented application code to deliver an open, standards-based version of the existing application using the frameworks and an application server provides run-time processing for the open-standards version of the existing application.

Another embodiment of a system for modeling and generating reusable application component frameworks, and automated assembly of service-oriented applications from existing applications includes an application parser for decomposing an existing application into a logical source application model and producing application system model artifacts. A framework generator uses said logical source application model to generate open, reusable business service component and system service component frameworks. The frameworks provide context-based and non-context-based business service components. A services generator generates services-oriented application code and assembles services-oriented application code utilizing said frameworks and an open standards-based composite application services application programming interface provides a business service process.

Advantageously, embodiments of the present systems and methods provide a comprehensive solution to enable migration to an open, standards-based platform utilizing the same personnel and skill sets as an existing application. Another advantage of embodiments of the present systems and methods is the degree of automation employed, which obviates any need for manual conversion, reducing costs and risks while saving time. Embodiments of the present systems and methods streamline the application development processes by removing uncertainty and providing a prescriptive incremental approach to development. Preferably, application code resulting from the present methods is open-standards-based, such as Java, providing an open J2EE solution. Additionally, solutions provided in accordance with the present invention are preferably design patterm-based, and may employ standards such as Model View Controller (MVC). Advantageously, embodiments of the present systems and methods deliver both a short-term and long-term solution by conversion to an open, standards-based application. In the short-term, in accordance with the present invention, existing developer and user skill sets may be directly utilized to maintain the resulting components and/or the open standards-based application. In the long-term, existing developer and user skill sets may be upgraded and/or evolved using open-standards-based components to maintain and extend the open, standards-based application. As a result, “natural evolution” of an application is allowed to take place outside of the products provider, on-site, to conform to a user's and developer's needs, avoiding the restraints proprietary technology platform exhibit.

Therefore, embodiments of the present systems and methods provides explicit support for business goals, paves the way to open standards-based enterprise SOA strategy implementation, provides socio-technical transitioning strategy to reduce risks and expenses and provides near-term and incremental long-term solutions.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flowchart of an embodiment of decomposition of an existing application and creation of an open standards-based version of the existing application in accordance with the present methods;

FIG. 2 is a flowchart of an embodiment of decomposition of an existing application and creation of open standards-based business components in accordance with the present methods;

FIG. 3 is a more detailed flowchart of an embodiment of decomposition of an existing application and creation of open standards-based business components and/or a open standards-based version of the existing application in accordance with the present methods; and

FIG. 4 is a diagrammatic illustration of an embodiment of the present systems, employing embodiments of the present methods.

### DETAILED DESCRIPTION

Various embodiments of the present systems and methods decomposes existing monolithic GUI-implemented client/server applications into open standards-based, re-usable business components according to a framework with separate user interface, business logic, and event management layer functionality. The present systems and methods interprets the current business models and processes as embodied in the existing application, to produce a logical model as the basis for transformation of one or more of the business processes of the existing application into one or more open standards-based, re-usable business components in the business component framework. Also, this logical model maybe used for artifact development such as analysis documentation (use cases, activity diagrams, class diagrams, collaboration diagrams, and the like).

The transformation separates former tightly-coupled isolates presentation logic elements into stateless components and stateful business domain logic components to provide a business services layer in which individual business components can be published and consumed as services singly, or as hierarchies and/or collaborations. The business components are presented as source system metaphor abstractions (such as Form, Block, Item, and Trigger, in the case of an Oracle Forms application system) as an architectural frame of reference for re-assembly into new standalone applications or new composite applications.

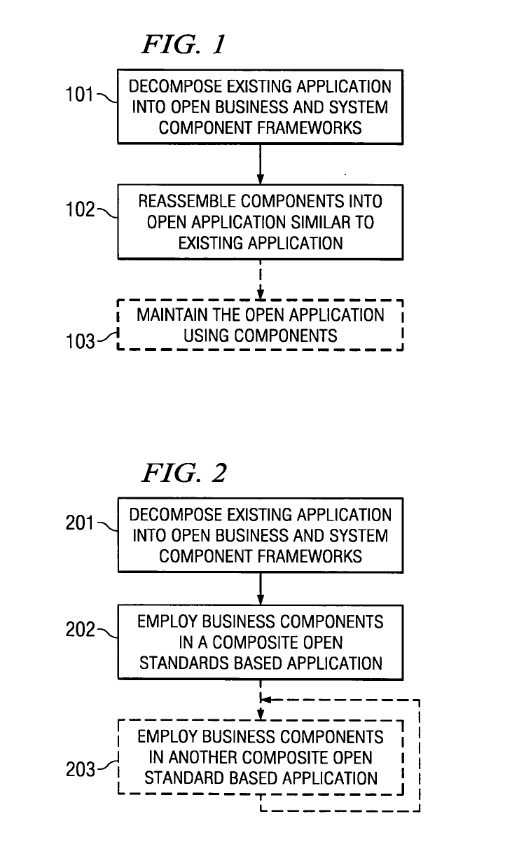

FIG. 1 is a flowchart of embodiment 100 of decomposition of an existing source application and creation of an open standards-based version of the existing application in accordance with the present methods. At 101 an existing application, is decomposed into one or more open standards-based business components which may be distributed in one or more frameworks. The existing application may be monolithic, for example a graphical user interface-implemented client/server application, or the like. The frameworks may include a business service component framework and/or a system service component framework, which in turn may include a presentation or user interface, business logic, and/or event management capabilities. At 102 the components are reassembled into an open standards-based application for service oriented architectures, utilizing the framework(s) and rendering a similar appearance and behavior for the open-standards-based application as provided by the existing application. Preferably this similar appearance and behavior for the open-standards-based application provides support for the same end-user's business processes and user experience as the existing application. Preferably, the reassembling provides a production code for the open-standards-based application that is similar to a production code of the existing application, in terms of the source application's language and its abstraction from low level third-generation (3GL) languages, such as Java. As is discussed in greater detail below the business components may be reused as business components in an external, open standards-based application, at a desired level of granularity. Additionally, as indicated at 103 the resulting open standards-based application may be maintained, updated or evolved using other available business components.

FIG. 2 is a flowchart of embodiment 200 for decomposition of an existing source application and creation of open standards-based business components in accordance with the present methods. At 201 an existing application is also decomposed into one or more open standards-based business components in one or more frameworks. Here too, the existing application may be a graphical user interface-implemented client/server application and the separate layers may be a user interface, business logic, and/or event management layers. Also, the frameworks in this case may include at least a business service component framework and a system service component framework At 202 the business components are employed in an external service oriented architecture application, or the like, at a desired level of granularity, such as according to the external composite application's business process support requirements. The business components may be reused in other external service oriented architecture applications, or the like at 203, also at a desired level of granularity. Additionally, as discussed above, and in greater detail below, the business components may be reassembled using open standards-based native application services into an open standards-based application. This reassembling preferably renders a similar appearance and behavior for the open-standards-based application as that provided by the existing application, that provides a same end-user's business processes and user experience as the existing application and a production code for the open-standards-based application similar to a production code of the existing application.

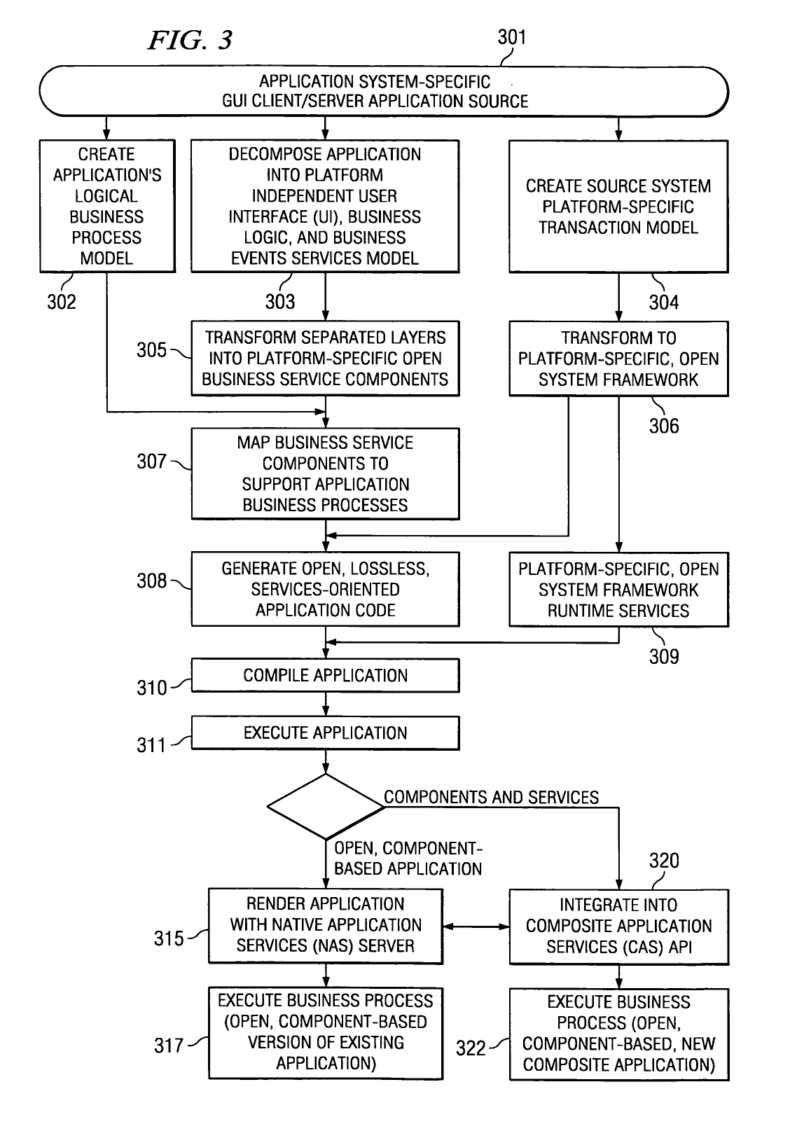

FIG. 3 is a flowchart of embodiment 300 for decomposition of an existing source application and creation of open standards-based business components in accordance with the present methods. At 301 and existing application source, such as a GUI-implemented client/server application. Concurrently at 302, 303 and 304, a set of logical models of the source application may be created (302); the application may be decomposed into a platform-independent Model View Controller (MVC) architecture. (303); and a source system platform specific transaction model may be created (304). As created at 303, the MVC View may contain a presentation of a UI; the MVC Model may contain domain and business logic pertaining to business processes supported by the source application; and/or the MVC Controller may manage events for the transaction state of business process implementation. At 305 the source application logical models may be transformed into platform-specific open standard-based business service components. At 307 the logical business process model from 302 and business components from 305 are used to map business service components to support application business processes. At 308 this mapping is used in conjunction with the source system platform-specific transition model created at 304, which has been transformed to a platform-specific, and open, system framework at 306, to generate open, standards-based services-oriented application code, in a lossless manner. This code is compiled at 310, employing platform specific open systems framework runtime services derived at 309 from the platform specific open system framework of step 306. The compiled application is executed at 311 to provide an open standards-based application 317, which may be employed by a user through native application services server 315, and/or open, standards-based composite applications 322, through a composite application services API to execute specific application business services, such as through the native application server.

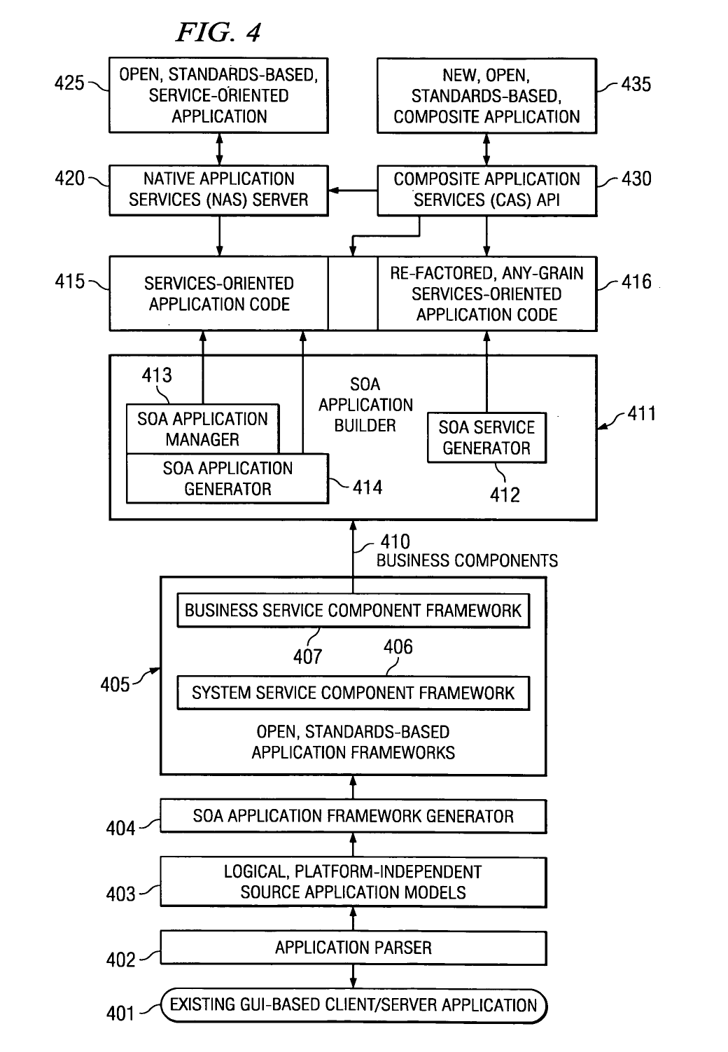

FIG. 4 is a diagrammatic illustration of embodiment 400 of the present systems, employing embodiments of the present methods. Embodiment 400 of the present systems and methods employs several modules to transform, manage, and extend existing source applications, such as GUI client/server application 401, into open and reusable business components for SOA use.

According to at least one embodiment of the present invention, application parser 402 interprets the technical instantiation of current business models and processes as embodied in the functionality of existing application 401 to produce a series of logical and platform independent source application models 403, that can be transformed to generate open application program code for new, specific target platforms or platform-independent services. The models produced by application parser 402, may be defined using a modeling meta-language or may be based on the Unified Modeling Language (UML) meta-model and Object Constraint Language (OCL) constructs, a combination thereof, and/or the like. Models 403 may include an application business process model, a domain model encompassing the business processes implemented by existing application functionality—this may be documented as UML+OCL based constructs to support the generation of ancillary artifacts including application requirement documentation, such as use cases, or the like. Models 403 may also include an application services model of the user interface, business logic, and event management service layers, which may be used to support a business process flow. A system services model (403) may be an abstraction of platform services required to implement transaction integrity for the business process flows supported by the existing (and resulting open systems-based) application.

Application framework generator 404 may then generate platform-specific reusable component frameworks 405, for example, business service component framework 407 and system service component framework 406, from models 403. This transformation may automatically map one or more constructs in a source application models into one or more platform-specific language constructs (particularly, in the case of J2EE platform, Java and XML) in the component frameworks using MVC design patterns to partition generated code into platform-specific architectures for user interaction and events, platform system services, and business objects. This transformation process preferably isolates the existing application's presentation, presentation logic, and business logic elements, whether or not they depend on application context, into stateless and stateful business domain logic elements to provide a business services layer for the service-oriented development of applications in which individual business service components can be published and consumed as services, singly or as hierarchies and/or collaborations.

Service-oriented application code generated by Framework Generator 404 may be presented using source application system metaphor abstractions and nomenclature (such as Form, Block, Item, Trigger, and other objects, and the PL/SQL language abstraction, in database applications, such as Oracle applications). These abstractions and nomenclature may be used as an architectural frame of reference for promoting meaningful aggregation of services for application reassembly into new standalone applications, or for the support of new business processes in new composite applications. In addition, the technique of applying the source application's system metaphor results in generated source code that is more amenable to maintenance by software developers of the existing source application system. These abstractions also promote developer productivity as they encompass one or more low level language constructs and existing programming practices that can be redeployed on an open standards-based platform. Preferably, runtime efficiency can be enhanced since the code-size of a resulting open standards-based application 425 is comparable to existing application 401.

The services provided by business service component and system service component frameworks 407, 406 can be used by SOA application builder 411 to assemble new service-oriented application code 415 and 416, through application generator 414 and application manager 413 . Services-oriented application code 415 may be partitioned into separate computing tiers consistent with the open, standards-based platform, such as J2EE, for network performance and scalability.

Application builder 411, which may take the form of a plug-in for a standard third party open or open source Integrated Development Environment (IDE), such as Eclipse, generates application code 415, 416 executables by using the predefined business and system service components 410 to produce open standards based version 425 of the original application 401, that executes the original Application 401's business processes using a user interface and user experience very similar to that of original application 401, throughout an application session.

At compile time, application builder 411 may link the business service component framework 407 with system service component framework 406 to compile application-specific components on an open, standards-based platform to deliver ready-to-execute open application code 415. In case of the J2EE platform, business service components comprising a presentation tier are compiled as distinct view classes in the MVC architecture, while those components comprising the business services tier are compiled as distinct model classes. Together, these classes are linked by application-specific event logic that is linked with a controller in system service component framework 406. The partitioned classes may be compiled and packaged for deployment as a single execution file 415 on native application services server 420.

At run time, native application server 420 may render an open, standards-based version of the source application 425 by choreographing execution of the business service and system service framework components and their interactions using dynamic user interface-invoked events to provide user context and application state for the execution of the business process to provide a similar or same appearance and behavior of open standards-based application 425 as provided by existing application 401. In J2EE, the open, MVC-decoupled, standards-based application 425 may be deployed onto separate computing tiers, for network performance and scalability.

Many UI rendering technologies are available from 3rd-parties, such as Swing, based on Java Foundation Classes (JFC) and Java Server Faces (JSF) from Sun Microsystems, FlashMx from Macromedia, and others. Preferably, the present systems and methods support at least these external UI rendering technologies, and preferably also offers an alternative for low-bandwidth networks, where network efficiency is a primary concern. A “thin-but-rich” HTML, “HTML NativeForms”, requires no plug-in, rendering only HTML widgets in the Web browser, and therefore may be more efficient over Wide Area Networks (WANs). The HTML NativeForms UI client generation and rendering technology delivers near identical appearance GUI screens in open application 425 as compared with source application 401, with possibly lower network overheads than associated with alternative UI rendering libraries, such as Swing.

Open application 425 may evolve over time and may be maintained using declarative (non-programmatic) access methods in application builder 411, such as to visually drag, drop, and maintain application-specific functionality, thereby updating the application composition including adding alternative standards-based interfaces (such as Java, XML, HTTP, SOAP, & COM). Application builder 411 may declaratively bind business service components with the underlying system service components to rapidly realize enhanced, extended, or new functionality ready for execution in open application 425.

In order to simplify transition to open application frameworks for productive maintenance, the application builder 411 preferably provides a developer experience of access, design, edit, and test tasks that emulate the processes used by developers of source application 401. By emulating the principles of maintenance in source application 401, the application builder 411's design and regeneration approach can provides a gradual transition from source application 401's to the open application 425's development environment.

Alternatively and additionally, certain business service components produced from the migrated application can be reused and repurposed, possibly through re-factoring, for use in new applications 435 at any desired level of granularity (regardless of their usage, context, or complexity in supporting the original application). This may result in 435 taking the form of a composite application. Through composite application services API 430, the business service generator 412 can publish protocol independent, location agnostic and loosely coupled services for encapsulation in higher level services using public API's for third party development environments such as portal frameworks, which coordinate execution of multiple business applications to support high level business processes. These protocol-independent, location agnostic and loosely coupled services may take the form of re-factored, services-oriented application code 416, of varying granularity. According to embodiments of the present systems and methods, for fine-grain services, business service generator 412 exposes specific, lowest-level units of business processing in GUI Source Application 401. These specific, lowest-level units of business processing may be available as Web Services, regardless of whether the unit of business processing was context-based (stateful), context-free (stateless), UI-based, UI-free. For coarse-grain services, business service generator 412 may aggregate fine-grain services and may produce Web Services that represent logical business transactions, spanning objects in the source application 401 business object hierarchy. Fine or coarse-grained services may be interactive or batch, which may then be published in public or private registries, such as Universal Description, Discovery, and Integration (UDDI), and may also be used in high-level business flows which can integrate with other applications and thereby deliver composite applications.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method comprising:
decomposing an existing source application into one or more open standards-based business components in one or more frameworks; and
reassembling said components into an open standards-based application for service oriented architectures utilizing said frameworks.

2. The method of claim 1 wherein said decomposing further comprises parsing said existing application to derive a platform-independent logical model to describe said exist application's functionality and implementation.

3. The method of claim 2 wherein said existing application's functionality and implementation includes at least one of business domain, application functionality characteristics, and implementation platform.

4. The method of claim 1 wherein said reassembling further comprises rendering a similar appearance and behavior for said open-standards-based application as provided by said existing application.

5. The method of claim 4 wherein said similar appearance and behavior for said open-standards-based application provides a same end-user's business processes and user experience as said existing application.

6. The method of claim 1 wherein said reassembling provides a production code for said open-standards-based application similar to a production code of said existing application.

7. The method of claim 6 wherein said similar code for said open-standards-based application enables reuse of developer skills associated with said existing application.

8. The method of claim 1 wherein said one or more frameworks comprise a plurality of frameworks.

9. The method of claim 8 wherein said plurality of frameworks comprise at least a business service component framework and a system services component framework.

10. The method of claim 1 further comprising:
reusing said business components in an external application.

11. The method of claim 10 wherein said business components are used at a desired level of granularity in said external application.

12. The method of claim 1 wherein said existing application is a graphical user interface-implemented client/server application.

13. The method of claim 1 wherein each framework comprises one or more of presentation, business logic, and event management capabilities.

14. The method of claim 1 further comprising:
maintaining said open standards-based application using business components.

15. A method comprising:
decomposing an existing application into one or more open standards-based business components in one or more frameworks; and
using said business components in an external service oriented architectures according to said one or more frameworks.

16. The method of claim 15 wherein said decomposing further comprises parsing said existing application to derive a platform-independent logical model to describe said exist application's functionality and implementation.

17. The method of claim 16 wherein said existing application's functionality and implementation includes at least one of business domain, application functionality characteristics, and implementation platform.

18. The method of claim 15 wherein said business components are reusable.

19. The method of claim 15 wherein said business components are used at a desired level of granularity in said external application.

20. The method of claim 15 wherein each framework comprises one or more of presentation, business logic, and event management.

21. The method of claim 15 wherein said one or more frameworks comprise a plurality of frameworks.

22. The method of claim 21 wherein said plurality of frameworks comprise at least a business service component framework and a system services component framework.

23. The method of claim 15 further comprising:
reassembling said component using open standards-based native application services in to an open standards-based application.

24. The method of claim 23 wherein said reassembling further comprises rendering a similar appearance and behavior for said open-standards-based application as provided by said existing application.

25. The method of claim 24 wherein said similar appearance and behavior for said open-standards-based application provides a same end-user's business processes and user experience as said existing application.

26. The method of claim 23 wherein said reassembling provides a production code for said open-standards-based application similar to a production code of said existing application.

27. The method of claim 26 wherein said similar code for said open-standards-based application enables reuse of developer skills associated with said existing application.

28. The method of claim 23 further comprising: maintaining said open standards-based application using business components.

29. The method of claim 15 wherein said existing application is a graphical user interface-implemented client/server application.

30. A system comprising:
an application parser for decomposing an existing application into a logical source application model and producing application system model artifacts;
a framework generator, using said logical source application model to generate open, reusable business service component and system service component frameworks, the frameworks providing context-based and non-context-based business service components;
an application builder generating services-oriented application code to deliver an open, standards-based version of said existing application using said frameworks; and
a server providing run-time processing for said open-standards version of said existing application.

31. The system of claim 30 wherein said open, component-based services-oriented application code is input to said server to provide said open-standards version of said existing application in a manner that is similar in appearance and behavior to said existing application.

32. The system of claim 30 wherein said framework generator also maps functionality of said existing application to appropriate business service components and partitions to appropriate tiers in an open, standards-based application server on a computer network.

33. The system of claim 30 wherein said server uses said frameworks to interpret user actions and interactions, and to implement user-triggered operations and associated internal system response operations.

34. The system of claim 30 wherein said application builder comprises:
an application manager that interprets business service components created by said application builder to maintain said the open standards-based version of said exist application.

35. The system of claim 34 wherein the maintenance of claim 32 comprises binding appropriate business service components and system service components to fulfill said open-standards version of said existing application business processes through functionality in a manner consistent with said existing application.

36. The system of claim 35 wherein the binding appropriate business services components and system service components is carried out by compiling and packaging a set of classes, constituents of both the system and business service components, for deployment as a single execution file on an open application server.

37. The system of claim 36 wherein said compilation, and packaging by said application builder integrates loosely coupled business service components using design patterns to produce the presentation tier as view classes in Model View Controller architecture, and to produce the business services tier as model classes.

38. The system of claim 37 wherein said view and model classes are connected by said application builder through application-specific event logic that is linked with a controller in said system service component framework.

39. The system of claim 30 wherein said application builder further comprises a services generator that generates business services from a services-oriented application code at a grain of abstraction present in said existing application, in a protocol-independent and location-agnostic manner.

40. The system of claim 39 wherein the generated business services are implemented within a new composite application.

41. The system of claim 40 wherein the generated business services are implemented within a composite application using an application programming interface.

42. The system of claim 41 wherein the implementation provides at least one of access, interoperability, and usage of business services for consumption by external applications through open standards.

43. The system of claim 39 wherein said services generator, through said application builder utilize services-oriented code for composite applications provides an application programming interface to present business services as at least one of context-based business services, non-context-based business services, context-based business components, and non-context-based business components, suitable for use by external applications as business process services.

44. The system of claim 30 wherein said application manager includes declarative programming methods and emulates existing source application development metaphors, abstractions, and nomenclature to maintain application-specific functionality.

45. The method of claim 30 wherein said server provides run-time processing for one or more of new, component-based, composite, open standards-based applications.

46. The system of claim 30 wherein said server is comprised of a native application services server and a composite application services application programming interface.

47. The system of claim 46 wherein said run-time processing for an open-standards version of the original existing application is provided by said native application service server.

48. The system of claim 46 wherein run-time processing for one or more of new, component-based, composite applications is provided through said composite application services application programming interface.

49. The system of claim 48 wherein said composite application services application programming interface exposes a business service present in said existing application.

50. The system of claim 46 wherein said composite application services application programming interface provides one or more application programming interfaces to said native application services server for open access through open standards.

51. The system of claim 50 wherein said open standards comprise at least one of XML, Web Services, Java, and Java 2 Enterprise Edition.

52. The system of claim 51 wherein said application programming interfaces may be provided to application-specific services at one or more of:
one or more levels of granularity;
functional partitioning at logical levels of use; and
interest to an external application; formerly not accessible in the existing application.

53. The system of claim 30 wherein said business components generated by said application framework generator are loosely-coupled.

54. The system of claim 30 wherein said business components generated by said application framework generator conform to industry-standard Model View Controller-based de-coupled architectures.

55. The system of claim 30 wherein said business components generated by said application framework generator have separate user interface view, business logic model, and user-event and system-event controller handlers.

56. The system of claim 30 wherein said application framework generator maps structure of said existing application to appropriate tiers in a Model View Controller-based de-coupled architecture of said open-standards version of said existing application.

57. The system of claim 30 wherein said application manager interprets said components to resemble programming syntax and semantics of said existing application.

58. The system of claim 30 wherein said application manager provides graphical productivity tools similar to said existing application's development tools.

59. The system of claim 30 wherein said application manager provides graphical productivity tools similar to an integrated development environment of said existing application.

60. The system of claim 30 wherein said existing application is a graphical user interface client/server application.

61. The system of claim 30 wherein said existing application is a graphical user interface-based client/server runtime engine application.

62. The system of claim 30 wherein said existing application is a database application and said business functions are partitioned along a plurality of objects and their associated scoping levels in said existing application's object hierarchy.

63. The system of claim 62 wherein said scoping levels comprise at least one of form, block, and item levels.

64. The system of claim 30 wherein a programming architecture of said open standards is Java.

65. The system of claim 30 wherein a programming architecture of said open standards is XML-based.

66. A system comprising:
an application parser for decomposing an existing application into a logical source application model and producing application system model artifacts;
a framework generator, using said logical source application model to generate open, reusable business service component and system service component frameworks, the frameworks providing context-based and non-context-based business service components;
a services generator generating services-oriented application code and assembling services-oriented application code utilizing said frameworks; and
an open, standards-based composite application services application programming interface capable of externally exposing and externally publishing a business service process.

67. The system of claim 66 wherein said services generator further comprises a services generator that generates business services from a services-oriented application code at any-grain of abstraction in the existing source application, in a protocol-independent and location-agnostic manner.

68. The system of claim 66 wherein a native application server executes said business service process for a new composite services-oriented application.

69. The system of claim 68 wherein said native application server provides runtime processing for an open-standards version of the original existing application.

70. The system of claim 66 wherein said framework generator also maps functionality of said existing application to appropriate business service components and partitions to appropriate tiers in an open standards-based application server.

71. The system of claim 66 wherein said application programming interface uses said open, standards-based application framework to interpret and implement events triggered by the composite application.

72. The system of claim 66 wherein Model View Controller architecture view and model classes are connected by said services generator through application-specific event logic that is linked with a controller in said system service component framework.

73. The system of claim 66 wherein said composite application services application programming interface exposes a business service present in said existing application.

74. The system of claim 66 wherein said composite application services application programming interface provides one or more application programming interfaces for open access through open standards.

75. The system of claim 74 wherein said open standards comprise at least one of XML, Web Services, Java, and Java 2 Enterprise Edition.

76. The system of claim 74 wherein said application programming interfaces may be provided to application-specific services at one or more of:
one or more levels of granularity;
functional partitioning at logical levels of use; and
interest to an external application; formerly not accessible in the existing application.

77. The system of claim 66 wherein said business components generated by said framework generator are loosely-coupled.

78. The system of claim 66 wherein said business components generated by said framework generator conform to industry-standard Model View Controller-based de-coupled architectures.

79. The system of claim 66 wherein said business components generated by said application framework generator have separate user interface view, business logic model, and user-event and system-event controller handlers.

80. The system of claim 66 wherein said existing application is a graphical user interface client/server application.

81. The system of claim 66 wherein said existing application is a graphical user interface-based client/server runtime engine application.

82. The system of claim 66 wherein a programming architecture of said open standards is Java.

83. The system of claim 66 wherein a programming architecture of said open standards is XML-based.
